(19) United States
(12) Patent Application Publication
(10) Pub. No.: US 2015/0336845 A1
(43) Pub. Date: Nov. 26, 2015

(54) METHOD AND SYSTEM FOR INCREASING THE CALORIFIC VALUE OF A MATERIAL FLOW CONTAINING CARBON

(71) Applicant: THYSSENKRUPP INDUSTRIAL SOLUTIONS AG, Essen (DE)

(72) Inventors: Karl LAMPE, Ennigerloh (US); Richard ERPELDING, Soest (DE); Jürgen DENKER, Beckum (DE); Meike DIETRICH, Münster (DE); Dirk SCHEFER, Ennigerloh (DE); Werner BROSOWSKI, Hamm (DE)

(73) Assignee: THYSSENKRUPP INDUSTRIAL SOLUTIONS AG, Essen (DE)

(21) Appl. No.: 14/410,106

(22) PCT Filed: Jun. 17, 2013
(86) PCT No.: PCT/EP2013/062534

§ 371 Date: Dec. 22, 2014

(30) Foreign Application Priority Data
Jun. 22, 2012 (DE) 10 2012 105 428.2

(51) Int. Cl. C04B 7/47; C10L 5/44; F27D 17/00; C04B 7/44; C10B 21/00; C10L 9/08; C10L 5/08

(52) U.S. Cl. CPC C04B 7/475; C10L 9/083; C10L 5/447; C10L 5/08; C04B 7/4407; C10B 21/00; F27D 17/001; C10L 2200/0469; C10L 2290/06; C10L 2290/08

(57) ABSTRACT

In the method according to the invention for increasing the calorific value of a material flow containing carbon, preferably a material flow of renewable raw materials, the material flow is brought in direct contact with at least one low-oxygen, inert hot gas flow in a reactor, wherein the hot gas flow is formed at least 50%, preferably at least 80%, by exhaust gas of a process for thermally processing cement raw meal and/or lime and/or an ore, wherein at least part of a preheater exhaust gas for preheating the cement raw meal and/or lime and/or ore is used as the hot gas flow.

The invention relates to a process and a plant for increasing the calorific value of a carbon-containing stream, preferably a stream composed of renewable raw materials, where the stream is brought into direct contact with at least one low-oxygen, inert hot gas stream in a reactor.

In thermal treatment processes, for example cement clinker and/or lime burning processes, pyro-metallurgical processes and/or processes for power generation and/or oil recovery, large amounts of fuel are sometimes required and fossil fuels are mostly used. To decrease CO₂ emissions and with a view to sustainable utilization of resources, the operators of such plants are making efforts to replace at least part of the fossil fuels by substitute fuels, in particular CO₂-neutral biomass.

The use of biomass as fuel in cement production is known from U.S. Pat. No. 7,434,332 B2, according to which the moist biomass is dried by being brought into direct contact with exhaust air from a cooler. In contrast, U.S. Pat. No. 7,461,466 B2 describes an indirect drying process for moist biomass which uses clinker exhaust air in order to utilize the dried biomass subsequently as fuel in the cement production process.

However, the dried biomass can be utilized even more efficiently when it is used in the torrefied state. For the purposes of the present invention, torrefaction is the thermal treatment of biomass by pyrolytic decomposition under low-oxygen conditions at low temperatures of from 240 to 320° C. WO 2012/007574 describes such a process in which a carbon-containing stream is dried and torrefied in a tier oven in which a drying zone through which a first hot gas stream flows and a torrefaction zone through which a second hot gas stream flows are provided. A torrefaction gas stream discharged via an outlet from the torrefaction zone is subsequently burnt and heated in a combustion apparatus. The exhaust gas formed here is utilized in a heat exchanger for heating the gas stream used for drying, with the hot exhaust gas stream from the combustion apparatus being cooled to the torrefaction temperature and then recirculated to the torrefaction zone. The stream of material therefore comes into direct contact with the respective low-oxygen, inert hot gas stream both in the drying zone and in the torrefaction zone. Compared to indirect heating, the direct contact ensures significantly more efficient heat transfer. In addition, torrefaction can preferably be achieved using a low-oxygen and inert hot gas stream since otherwise undesirable uncontrollable exothermic reactions would occur in the torrefaction zone.

An apparatus and a process for producing a finely particulate fuel from solid or paste-like energy raw materials by torrefaction and comminution are known from DE 10 2009 053 059 A1. Furthermore, cogasification of biomass and coal in an entrained flow gasifier is being attempted, with the exhaust gas from the torrefaction being fed to the gasification and exhaust gas from the gasification being utilized in the torrefaction.

It is then an object of the invention to make the process and the plant for increasing the calorific value of a carbon-containing stream, preferably a stream composed of renewable raw materials, even more efficient.

This object is achieved according to the invention by the features of claims 1 and 11.

In the process of the invention for increasing the calorific value of a carbon-containing stream, preferably a stream composed of renewable raw materials, the stream is brought into direct contact with at least one low-oxygen, inert hot gas stream in a reactor, wherein the hot gas stream is formed to an extent of at least 50%, preferably at least 80%, by exhaust gas from a process for the thermal treatment of cement raw meal and/or lime and/or an ore, with at least part of a preheater exhaust gas from the preheating of the cement raw meal and/or lime and/or ore being used as hot gas stream.

For the purposes of the invention, a low-oxygen, inert hot gas stream is a hot gas stream which has an oxygen concentration of <8%, preferably <6%. This is significantly below the oxygen limit concentration for wood and other biomasses and prevents an oxidizing reaction of the biogenic components. The thermal treatment of biomass under these conditions leads to liberation of volatile components which cannot oxidize further and thus cause no additional heat input into the process zone.

The coupling of the torrefaction process to increase the calorific value of a carbon-containing stream with a thermal treatment process enables excess waste heat from the treatment process to be utilized as hot gas stream for the drying and torrefaction. In this way, hot gas can be provided without, or at least with relatively little, additional energy.

Further embodiments of the invention are subject matter of the dependent claims.

A further increase in efficiency is obtained when the process for increasing the calorific value of a carbon-containing stream is coupled with the thermal treatment process not only in respect of the provision of the hot gas but also in the reverse direction by the carbon-containing stream which has been treated in the reactor being utilized as solid fuel in the thermal treatment process and/or an exhaust gas from the reactor being fed as gaseous fuel to the thermal treatment process.

For the purposes of the patent application, hot gases are exhaust gases from the process for the thermal treatment of cement raw meal and/or lime and/or ore which have a temperature of at least >200° C. and a maximum oxygen concentration of 8%, preferably less than 6%. Exhaust gases from these thermal processes having temperatures above 400° C. can be cooled by means of colder low-oxygen exhaust gas streams, which can optionally also originate from the circuits of the torrefaction process, to the required temperature.

The hot gas stream is preferably introduced at a temperature of less than 400° C. and an oxygen content of less than 8% into the reactor. In a preferred embodiment, the hot gas stream is utilized for the drying and/or torrefaction of the stream in the reactor. Here, an exhaust gas formed in the drying from the drying region can be utilized for recovery of water. Furthermore, a torrefied material formed in the torrefaction can be cooled and a cooler exhaust gas formed in the cooling can be used as hot gas stream for drying of the stream.

A torrefied material formed in the torrefaction can be milled and/or briquetted hot in order to then be used as solid fuel. Furthermore, it is conceivable for biocarbon which is used as reducing agent in a pyrometallurgical process to be produced in the torrefaction. In addition, at least part of an exhaust gas discharged from the reactor can be utilized for recovering an organic acid by the exhaust gas being introduced into a condenser and/or rectification column. Furthermore, it is conceivable for a torrefied material formed in the torrefaction to be fed after hot or cold milling to an entrained flow gasifier or uncomminuted to a fluidized-bed gasifier for the production of combustible gases.

The invention further provides a plant for the thermal treatment of cement raw material, limestone or ore and for increasing the calorific value of a carbon-containing stream, comprising a preheater for preheating and/or calcining cement raw material, limestone or ore and a reactor in which the stream of material is brought into direct contact with at least one low-oxygen, inert hot gas stream, wherein the preheater is connected to the reactor in order to feed preheater exhaust gases obtained in the preheater as hot gas stream to the reactor.

The reactor can, in particular, comprise a drying zone and a torrefaction zone, with the reactor being, for example, configured as a multitier oven. In a further embodiment, the reactor has an exhaust gas line for the discharge of exhaust gases formed in the reactor and this exhaust gas line is connected to the plant for the thermal treatment.

Further advantages and embodiments of the invention will be illustrated with the aid of the following description and the drawing.

The figures in the drawing show

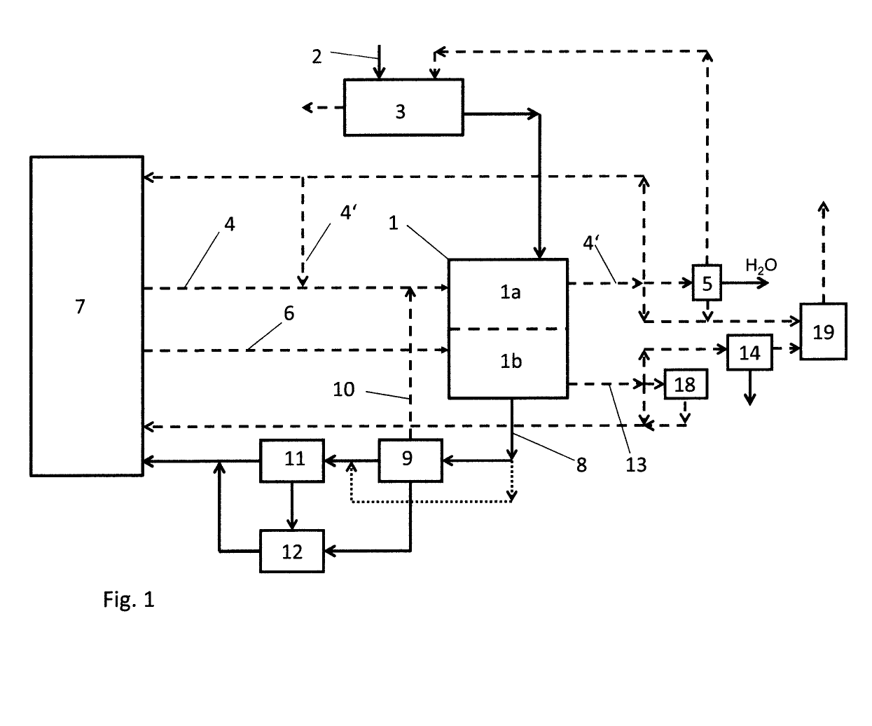

FIG. 1 a block diagram to illustrate the process of the invention and

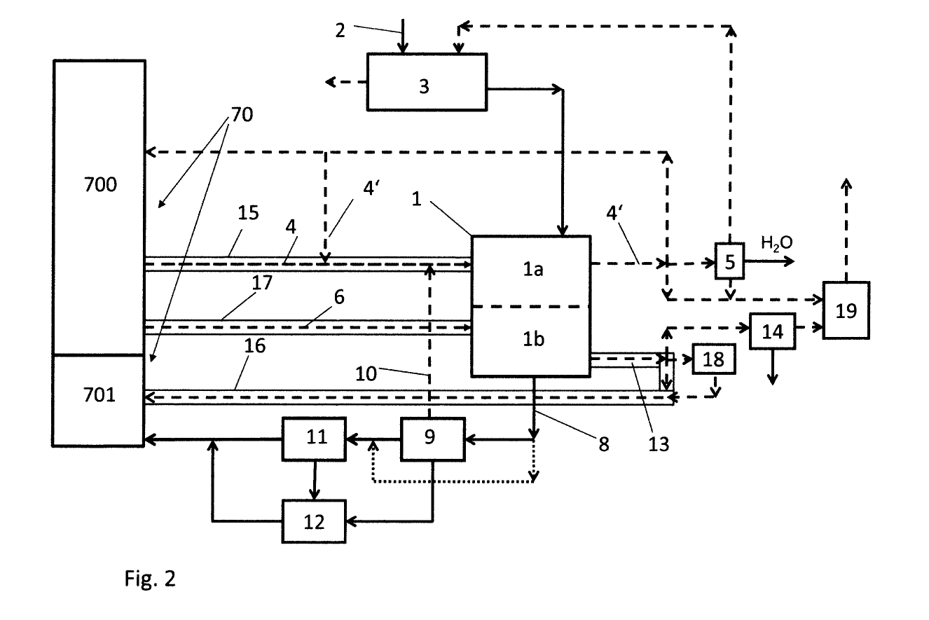

FIG. 2 a block diagram of a plant for the thermal treatment of cement raw material, limestone or ore and a plant for increasing the calorific value of a carbon-containing stream.

In FIG. 1, the reference numeral 1 denotes a reactor for increasing the calorific value of a carbon-containing stream 2, preferably a stream composed of renewable raw materials. This reactor is, for example, configured as a multitier oven having at least one upper process space and a lower process space, with the upper process space being configured as drying zone 1a and the lower process space being configured as torrefaction zone 1b.

In a preferred embodiment of the invention, the drying zone 1a and/or the torrefaction zone lb each consist of a plurality of superposed hearths. Rabble arms and rabble teeth, for example, which rotate around a central shaft are employed as transport means. Furthermore, a mechanical transfer device for transfer of the dried, carbon-containing stream can be provided between the two zones; this device is preferably made gastight in order to prevent mixing of the two atmospheres.

The carbon-containing stream 2 is fed into the drying zone 1a and optionally pretreated beforehand in a mill or press 3. In the drying zone, the carbon-containing stream 2 comes into direct contact with a low-oxygen, inert first hot gas stream 4 and is thereby dried. The temperature of the hot gas stream 4 is advantageously in the range from 150° to 400° C., preferably in the range from 200° C. to 300° C. The oxygen content is preferably less than 8%.

The hot gas stream 4 takes up the moisture of the stream 2 and is discharged as exhaust air 4′ from the drying zone 1a and can then, for example, be fed to a condenser 5 to recover water or back to the thermal treatment process 7 or discharged directly via a stack 19.

The hot gas stream 4 is formed by an exhaust gas from a thermal treatment process 7 which is taken off at a place which gives the desired properties in respect of oxygen content and temperature. In addition, it is possible to mix a substream of the dryer exhaust gas 4′ into the hot gas stream 4 in order to set the desired properties of the hot gas. The thermal treatment process 7 can be, for example, a cement clinker process and/or lime burning process, a pyrometallurgical process and/or a process for power generation and/or oil recovery.

The stream 2 which has been dried by the hot gas stream 4 in the drying zone 1a subsequently goes into the torrefaction zone 1b in which it is brought into direct contact with a low-oxygen, inert second hot gas stream 6. The temperature of the second hot gas stream 6 is usually higher and is preferably in the range from 250° to 400° C. and brings about the torrefaction of the carbon-containing, dried stream 2. The second hot gas stream 6, too, is taken from the thermal treatment process 7 and can be adapted to the required properties by mixing-in of other exhaust gas streams, e.g. from the torrefaction process itself. According to the invention, the two hot gas streams 4, 6 for the reactor 1 are formed to an extent of at least 50%, preferably at least 80%, by an exhaust gas from the thermal treatment process 7.

In the torrefaction zone 1b, the carbon-containing stream is converted into a torrefied material 8 which can be utilized as solid fuel in the thermal treatment process 7. The torrefied material 8 can be cooled beforehand in a cooler 9, with a cooler exhaust gas 10 formed being able to be utilized at least partly as first hot gas stream 4 in the drying zone 1a for drying of the stream 2. However, the torrefied material 8 could also be milled and/or briquetted hot, without cooling, in a mill or press 11 before being utilized in the thermal treatment process 7. In addition, it is possible to temporarily store the torrefied material 8 in the cooled, milled or briquetted state in a hopper 12.

Apart from the torrefied material 8, an exhaust gas 13 is also formed in the torrefaction zone 1b and this can be utilized as gaseous fuel in the thermal treatment process 7. The combustible torrefaction gas 13 is either fed directly to the thermal treatment process 7 or after-combusted beforehand by means of a burner 18 and fed as hot exhaust gas into the treatment process 7. As an alternative, at least part of the exhaust gas 13 can be fed into a condenser 14 to recover acid and/or salt.

FIG. 2 shows an example in which the thermal treatment process is carried out in a plant 70 for the treatment of cement raw material, limestone or ore, which comprises at least one preheater 700 which is connected via a hot gas line 15 to the reactor 1 in order to feed preheater exhaust gases formed in the preheater as hot gas stream 4 to the reactor 1. In addition, a hot gas line 17 for supplying the second hot gas stream 6 connects the preheater 700 to the torrefaction zone 1b. The reactor 1 is additionally connected by means of an exhaust gas line 16 for conducting away the exhaust gas 13 formed in the reactor to the plant 70, for example a rotary tube furnace 701. If the plant 70 is a cement production plant, the rotary tube furnace 701 serves for firing the cement raw material which has been preheated and/or precalcined in the preheater 700 and a calciner which is optionally present to give cement clinker. The preheater is usually operated using the exhaust gas from the rotary tube furnace, which in terms of its oxygen content and the inert properties represents the ideal hot gas for the reactor 1. The required temperatures of the two hot gases 4, 6 are set by the preheater exhaust gas being taken off at precisely the place on the preheater 700 at which the preheater exhaust gas has the desired temperature or the preheater exhaust gas taken off is mixed with a further gas stream.

1. A process for increasing the calorific value of a carbon-containing stream (2), preferably a stream composed of renewable raw materials, where the stream is brought into direct contact with at least one low-oxygen, inert hot gas stream (4) in a reactor (1),
characterized in that the hot gas stream (4) is formed to an extent of at least 50% by exhaust gas from a process (7) for the thermal treatment of cement raw meal and/or lime and/or an ore, with at least part of a preheater exhaust gas from the preheating of the cement raw meal and/or lime and/or ore being used as hot gas stream (4).

2. The process as claimed in claim 1, characterized in that the carbon-containing stream (2) which has been treated in the reactor (1) is utilized as solid fuel in the thermal treatment process (7) and/or an exhaust gas (13) from the reactor (1) is fed as gaseous fuel to the thermal treatment process (7).

3. The process as claimed in claim 1, characterized in that the hot gas stream (4) is utilized for the drying and/or torrefaction of the stream (2) in the reactor (1).

4. The process as claimed in claim 3, characterized in that an exhaust gas (4′) formed in the drying is utilized for recovery of water.

5. The process as claimed in claim 3, characterized in that a torrefied material (8) formed in the torrefaction is cooled and a cooler exhaust gas (10) formed in the cooling is used as hot gas stream for drying of the stream (2).

6. The process as claimed in claim 3, characterized in that a torrefied material (8) formed in the torrefaction is milled and/or briquetted hot.

7. The process as claimed in claim 3, characterized in that a torrefied material (8) formed in the torrefaction is fed after hot or cold milling to an entrained flow gasifier or uncomminuted to a fluidized-bed gasifier for the production of combustible gases.

8. The process as claimed in claim 3, characterized in that biocarbon which is used as reducing agent in a pyrometallurgical process is produced in the torrefaction.

9. The process as claimed in claim 1, characterized in that the hot gas stream (4) is introduced at a temperature of less than 450° C. and an oxygen content of less than 8% into the reactor (1).

10. The process as claimed in claim 1, characterized in that at least part of an exhaust gas discharged from the reactor (1) is utilized for recovering an organic acid by the exhaust gas being introduced into a condenser and/or rectification column (14).

11. A plant (70) for the thermal treatment of cement raw material, limestone or ore and for increasing the calorific value of a carbon-containing stream, comprising a preheater (700) for preheating and/or calcining cement raw material, limestone or ore and a reactor (1) for carrying out the process as claimed in claim 1, wherein the preheater (700) is connected to the reactor (1) in order to feed preheater exhaust gases obtained in the preheater as hot gas stream (4) to the reactor (1).

12. The plant as claimed in claim 11, characterized in that the reactor (1) comprises a drying zone (1a) and a torrefaction zone (1b).

13. The plant as claimed in claim 11, characterized in that the reactor (1) is configured as a multitier oven having at least one upper process space and lower process space.

14. The plant as claimed in claim 11, characterized in that the reactor (1) has an exhaust gas line (16) for the discharge of exhaust gases (13) formed in the reactor (1) and this exhaust gas line (16) is connected to the plant (70) for the thermal treatment.

15. The plant as claimed in claim 11, characterized in that the plant (70) for the thermal treatment is formed by a cement production plant which comprises a rotary tube furnace (701) for the subsequent firing of the preheated cement raw material to give cement clinker.
